(19) United States
(12) Patent Application Publication
(10) Pub. No.: US 2025/0391621 A1
(43) Pub. Date: Dec. 25, 2025

(54) VACUUM CIRCUIT BREAKER

(71) Applicant: HYOSUNG HEAVY INDUSTRIES CORPORATION, Seoul (KR)

(72) Inventors: Jung Won YOON, Changwon-si, Gyeongsangnam-do (KR); Kwang Ho JEONG, Changwon-si, Gyeongsangnam-do (KR); Nam Gu KIM, Changwon-si, Gyeongsangnam-do (KR)

(21) Appl. No.: 18/878,086

(22) PCT Filed: Oct. 12, 2023
(86) PCT No.: PCT/KR2023/015690

§ 371 Date: Dec. 23, 2024

(30) Foreign Application Priority Data
Oct. 13, 2022 (KR) 10-2022-0131331

(51) Int. Cl. H01H 33/666; H01H 33/662

(52) U.S. Cl. CPC H01H 33/666; H01H 33/66238

(57) ABSTRACT

The present disclosure is a vacuum circuit breaker 20. The vacuum circuit breaker 20 may be installed in an inner space 12 of an outer casing 10 or may be installed penetrating the outer casing 10. The vacuum circuit breaker 20 includes a vacuum interrupter 210 and a linkage mechanism 230. The linkage mechanism 230 includes a piston 246 that provides a force to offset the self-sealing force of the vacuum interrupter 210. The piston 246 may have a larger diameter than the driving rod 254 penetrating the outer casing 10, and may have a diameter equal to or similar to the effective diameter of a bellows 224 in the vacuum interrupter 210.

### TECHNICAL FIELD

The present disclosure relates to a vacuum circuit breaker.

### BACKGROUND ART

A vacuum circuit breaker is a type of circuit breaker that employs a vacuum interrupter (VI) that uses vacuum as an arc extinction medium, and performs transmission, transfer, and interruption of electric power, and promptly and automatically shuts down when a fault occurs in a power system.

In this type of vacuum circuit breaker, the vacuum interrupter with vacuum inside is installed in an outer casing filled with an insulating gas at high or low pressure, and an operator operates the vacuum interrupter outside the outer casing.

However, the inside of the vacuum interrupter is in a vacuum state, and the inside of the outer casing in which the vacuum interrupter is installed is filled with insulating gas at a pressure greater than atmospheric pressure. Therefore, a movable rod of the vacuum interrupter is always subjected to a force to enter the vacuum interrupter due to the pressure difference between the inside of the outer casing and the inside of the vacuum interrupter. These forces are generally referred to as self-sealing force.

In addition, an operator for driving the movable rod of the vacuum interrupter is installed outside the outer casing. A driving rod for transmitting the driving force of the operator to the movable rod has no choice but to pass through the outer casing. The driving rod is directly connected to the movable rod and is affected by the self-sealing force, which interferes with the operation of the movable rod and the driving rod.

In particular, the vacuum interrupter installed inside the outer casing is inevitably affected by the pressure of the insulating gas inside the outer casing. The pressure value of the insulating gas may be added to the self-sealing force and may act in a direction that maintains a movable electrode of the vacuum interrupter in contact with a fixed electrode. In addition, this force may change the magnitude of the operating force that separates the movable electrode from the fixed electrode by the operator. In other words, if the pressure of the insulating gas in the outer casing is changed, the operating force of the operator should also be changed to meet the operational characteristics, leading to a complication in the design of the operator.

In addition, environmentally friendly gas is used as the insulating gas, and as the pressure inside the outer casing increases, the load applied to a bellows increases. Therefore, a high-pressure bellows must be used.

### DOCUMENTS OF RELATED ART

(Patent Document 0001) Korean Patent Publication No. 10-2016-0048320
(Patent Document 0002) Korean Patent Publication No. 10-2017-0058637
(Patent Document 0003) Korean Patent Registration No. 10-1060780

### DETAILED DESCRIPTION OF THE DISCLOSURE

### Technical Problem

An object of the present disclosure is to reduce a self-sealing force by having a linkage mechanism, which is installed penetrating an outer casing, simultaneously subjected to atmospheric pressure and the internal pressure of the outer casing.

An object of the present disclosure is to enable a target speed to be maintained constant during an interrupting operation in a vacuum circuit breaker.

### Technical Solution

According to the present disclosure for achieving the above objects, in a vacuum circuit breaker in which some parts are installed inside an outer casing and other parts are installed penetrating the outer casing, the following parts are disposed inside the outer casing: a vacuum interrupter having a vacuum space formed inside an housing and having a fixed electrode and a movable electrode that contacts and separates from the fixed electrode in the vacuum space; and a linkage mechanism that includes a driving rod which is installed penetrating the outer casing for transmitting a force for driving the movable electrode and a piston which is integral with the driving rod and has an outer diameter greater than that of the driving rod.

The linkage mechanism further comprises a piston guide installed penetrating the outer casing. A guide body of the piston guide may be provided with a rod through-hole through which the driving rod passes and communicates with the outside of the outer casing and a cylinder in which the piston is movably installed and opens into the outer casing.

An airtight packing and a piston wear ring may be provided between the outer surface of the piston and the inner surface of the piston space.

A rod wear ring may be provided between the inner surface of the rod through-hole and the outer surface of the driving rod.

A movable rod having one side connected to the movable electrode and the other side connected to the linkage mechanism may be provided passing through the housing, and a bellows may seal between the movable rod and the housing.

The effective diameter of the bellows and the outer diameter of the piston may have the same value.

A guide tube may be installed penetrating the housing, the movable rod may be positioned through the guide tube, and the bellows may be installed between the guide tube and the movable rod.

An insulating rod made of an insulating material may be further provided between the movable rod and the piston of the linkage mechanism.

The piston guide in which the piston and the driving rod of the linkage mechanism are installed may be installed penetrating the outer casing. A mounting flange may be formed around one side of the outer surface of the guide body forming the skeleton of the piston guide, so that one surface of the mounting flange may be in close contact with the outer surface of the outer casing.

The rod through-hole through which the driving rod passes may be formed penetrating the center of the guide body. A cylinder having a cylinder space in which one side of the cylinder communicates with the rod through-hole and the other side thereof communicates with the inner space of the outer casing may protrude toward the vacuum interrupter.

### Advantageous Effects

A vacuum circuit breaker according to the present disclosure may have at least one of the following effects.

In the present disclosure, a piston having a larger diameter than a driving rod is placed in a linkage mechanism constituting a vacuum circuit breaker and installed penetrating an outer casing. The piston provides a force equal to the force exerted by the pressure of the insulating gas inside the outer casing minus the force exerted by the atmospheric pressure outside the outer casing, thereby reducing the self-sealing force of the vacuum interrupter. Accordingly, there is an effect that the force required by an operator to drive a movable electrode is reduced.

In the present disclosure, a diameter of the piston (or the diameter of an airtight packing of the piston) receiving the force due to the pressure of the insulating gas inside the outer casing and the force caused by the atmospheric pressure and an effective diameter of a bellows receiving the self-sealing force are made the same, so that the self-sealing force is offset, and the target speed may be constant during an interrupting operation in the vacuum circuit breaker. Therefore, there may be an effect of facilitating the design of the operator for operating the vacuum circuit breaker.

### DESCRIPTION OF DRAWINGS

FIG. 1 is a schematic cross-sectional view showing that a preferred embodiment of a vacuum circuit breaker according to the present disclosure is installed in an outer casing.

FIG. 2 is an enlarged cross-sectional view showing a piston guide and a configuration related thereto in the embodiment shown in FIG. 1.

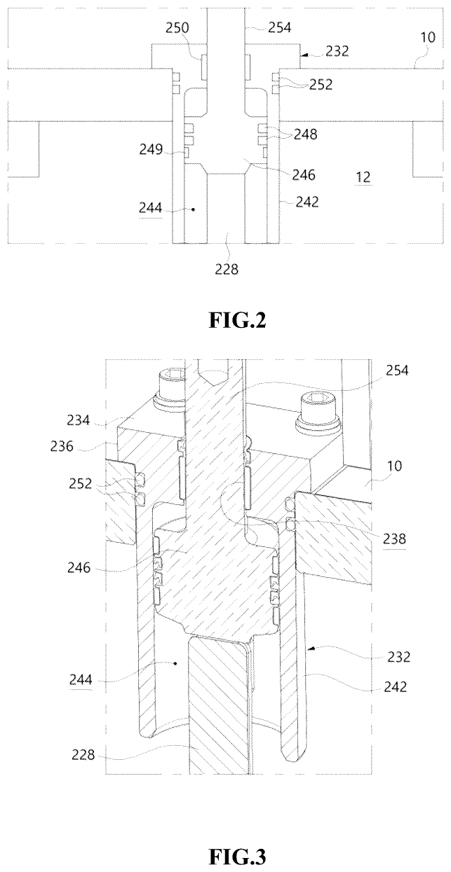

FIG. 3 is a cross-sectional perspective view showing a piston guide and a periphery thereof constituting the embodiment of the present disclosure.

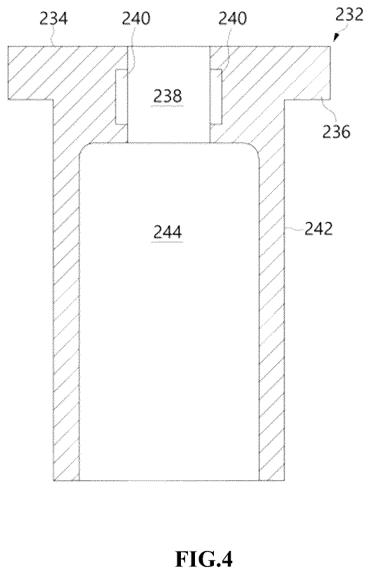

FIG. 4 is a cross-sectional view showing a configuration of the piston guide constituting the embodiment of the present disclosure.

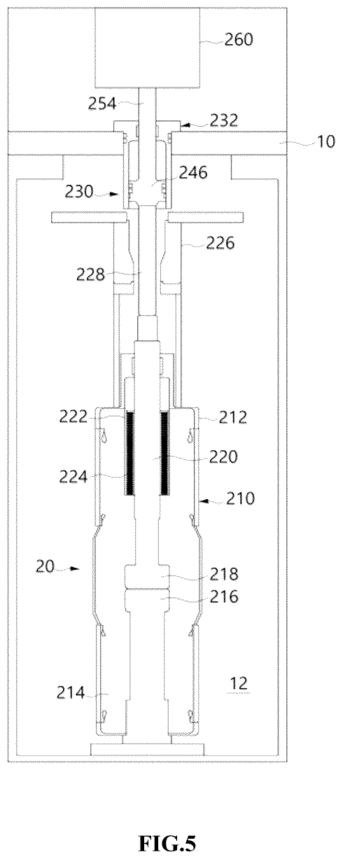

FIG. 5 is an operating state diagram showing an energized state in which a movable electrode is in contact with a driving electrode in the embodiment of the present disclosure.

FIG. 6 is an operating state diagram explaining that the pressure inside and outside an outer casing acts on a piston in the embodiment of the present disclosure.

FIG. 7A is an explanatory diagram showing the pressure acting on a driving rod and bellows in the prior art, and FIG. 7B is an explanatory diagram showing the pressure acting on a driving rod, piston, and bellows in the present disclosure.

### BEST MODE FOR DISCLOSURE

Hereinafter, some embodiments of the present disclosure will be described in detail with reference to exemplary drawings. In assigning reference numerals to the components of each drawing, it should be noted that the same components are given the same reference numerals as much as possible even though the same components are indicated on different drawings. In addition, in describing the embodiment of the present disclosure, if it is determined that a detailed description of a related known configuration or function interferes with the understanding of the embodiment of the present disclosure, the detailed description thereof will be omitted.

In addition, in describing the components of the embodiment of the present disclosure, terms such as first, second, A, B, (a), (b), etc. may be used. These terms are only used to distinguish between the components, and the nature, or order of the components are not limited by the terms. When a component is described as being “combined with”, “coupled to”, “combined with”, or “connected to” another component, the components may be directly connected to or combined with each other, but it should be understood that another component may be “coupled to”, “combined with”, or “connected to” each of the components therebetween.

As shown in the drawings, a vacuum circuit breaker (20) according to an embodiment of the present disclosure may be installed in an outer casing (10) having an inner space (12) formed therein. The inner space (12) of the outer casing (10) may be filled with an insulating gas. In the inner space (12) of the outer casing (10) may have various components including a vacuum circuit breaker (20) and conductors of the embodiment.

The vacuum circuit breaker (20) of the embodiment may include a vacuum interrupter (210) installed in the inner space (12) of the outer casing (10) and a linkage mechanism (230) installed penetrating the outer casing (10).

A housing (212) may form an outer appearance of the vacuum interrupter (210). A vacuum space (214) may be formed inside the housing (212). The inside of the vacuum space (214) may be maintained in a vacuum. A fixed electrode (216) is provided on one side of the inside of the vacuum space (214). The fixed electrode (216) may be electrically connected to the outside of the housing (212).

A movable electrode (218) may be movably installed in the housing (212) so as to contact and separate from the fixed electrode (216). The movable electrode (218) contacts the fixed electrode (216) to connect a line, and separates from the fixed electrode (216) to cut the line. A movable rod (220) is connected to the movable electrode (218). The movable rod (220) is connected to an operator (260) through the linkage mechanism (230), to be described below, to receive driving force to operate the movable electrode (218).

A guide tube (222) may be installed through the housing (212). The guide tube (222) may have a hollow cylindrical shape. The movable rod (220) may be installed through the inside of the guide tube (222).

A bellows (224) may be installed so that both ends thereof are connected to one side of the movable rod (220) and the other side of the guide tube (222), respectively. The bellows (224) may have a cylindrical shape with wrinkles throughout. The length of the bellows (224) may be varied. The bellows (224) may be installed between the movable rod (220) and the guide tube (222) to shield the inside of the housing (212) from the outside. That is, the bellows (224) may serve to prevent the vacuum space (214) of the housing (212) from communicating with the outside while allowing the movable rod (220) to move through the housing (212). The bellows (224) may be continuously wrinkled and may be expanded and contracted to vary in length. For example, the inner surface of one end of the bellows (224) may be coupled to one outer surface of the movable rod (220), and the outer diameter of the other end of the bellows (224) may be coupled to the inner surface of the guide tube (222).

The vacuum interrupter (210) may be fixed and installed within the outer casing (10) by an insulation support (226). The insulation support (226) may be fixed to one side of the inner space (12) of the outer casing (10) to support the vacuum interrupter (210) and the linkage mechanism (230), to be described below.

The movable rod (220) and a piston (246) of the linkage mechanism (230) may be connected by an insulating rod (228). The insulating rod (228) is made of an insulating material to insulate between the movable rod (220) and the piston (246), that is, the linkage mechanism (230).

The configuration of the linkage unit (230) will be described. The linkage mechanism (230) has a piston guide (232). The piston guide (232) may be installed penetrating the outer casing (10). The piston (246) and a driving rod (254) are positioned through the piston guide (232) to perform a linear reciprocating motion. In other words, the piston guide (232) may serve to guide the piston (246) and the driving rod (254) to move.

A guide body (234) may form the skeleton of the piston guide (232). The guide body (234) may have a cylindrical shape as a whole. The guide body (234) may have a mounting flange (236). The mounting flange (236) protrudes around one edge of the guide body (234). One surface of the mounting flange (236) is in close contact with the outer surface of the outer casing 10 so that the piston guide (232) may no longer enter the outer casing (10).

A rod through-hole (238) may be formed penetrating the center of the piston guide (232) in the longitudinal direction. The driving rod (254) may be movably positioned in the load through-hole (238). A ring channel (240) surrounding an inner surface of the load through-hole (238) may be formed. A load wear ring (250) to be described below may be positioned on the ring channel (240).

The guide body (234) of the piston guide (232) may have a cylinder (242). A piston space (244) is formed inside the cylinder (242). The piston space (244) communicates with the rod through-hole (238). A piston (246) to be described below may be installed in the piston space (244) to perform linear reciprocating motion. The cross section of the piston space (244) may be circular. The cross-sectional shape of the piston space (244) may be formed to be the same as the cross-sectional shape of the piston (246) to be described below. For example, if the cross-sectional shape of the piston space (244) is a square, then the cross-sectional shape of the piston (246) may also be a square.

The piston (246) may linearly reciprocate in the cylinder (242). One surface of the piston (246) may be exposed to the inner space (12) of the outer casing (10). This is because the cylinder (242) is open to the inner space (12). The piston (246) has a diameter greater than the diameter of the driving rod (254) to be described below.

One surface of the piston (246) may serve to receive pressure from the inner space (12). The other surface of the piston (246) may serve to receive atmospheric pressure outside the outer casing (10). In general, since the pressure in the inner space (12) of the outer casing (10) is greater than the atmospheric pressure outside the outer casing (10), the piston (246) may have a tendency to move toward the outside of the outer casing (10).

The outer diameter of the piston (246) may be equal to or similar to the effective diameter of the bellows (224). This is to ensure that the pressure of the inner space (12) acting on the piston (246) and the pressure of the inner space (12) acting on the bellows (224) are equal to or similar. Of course, the outer diameter of the piston (246) may be made larger than the effective diameter of the bellows (224) to relatively reduce or eliminate the self-sealing force.

Ring channels (not referenced) are formed surrounding the outer surface of the piston (246), and an airtight packing (248) may be installed in the ring channels. The airtight packing (248) is for maintaining airtightness. A piston wear ring (249) may be installed in one of the ring channels. The piston wear ring (249) may prevent wear caused by metal surface contact between the inner surface of the piston (246) and the cylinder (242) and eccentricity during operation. The piston wear ring (249) may be installed on the inner surface of the cylinder (242) instead of the piston (246).

A rod wear ring (250) may be installed in the ring channel (240) on the inner surface of the rod through-hole (238). The rod wear ring (250) may prevent wear caused by metal surface contact between the rod through-hole (238) and the driving rod (254) and eccentricity during operation. The rod wear ring (250) may be installed on an outer surface of the driving rod (254).

An airtight packing (252) may be installed between the outer surface of the guide body (234) of the piston guide (232) and the inner surface of the penetration portion of the outer casing (10). The airtight packing (252) may be installed on the guide body (234) or may be formed on the inner surface of the penetration portion of the outer casing (10). The airtight packing (252) may prevent leakage of insulating gas through a space between the outer surface of the piston guide (232) and the outer casing (10).

There is a driving rod (254) extending from the piston (246) to the outside of the outer casing (10). The driving rod (254) may be integrally formed with the piston (246). The driving rod (254) has a smaller diameter than the piston (246). The driving rod (254) may be connected to an operator (260). The driving rod (254) is connected to the operator (260) and receives the operating force provided by the operator (260) to control the operation of the movable rod (220) so that the movable electrode (218) contacts and separates the fixed electrode (216).

The following is a detailed description of the use of the vacuum circuit breaker according to the present disclosure which has the configuration described above.

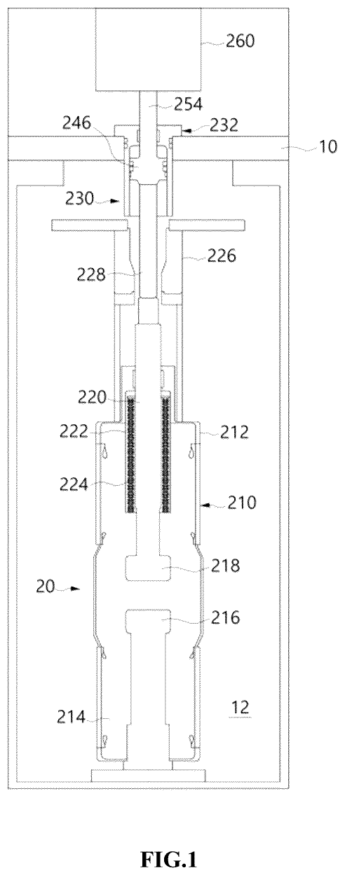

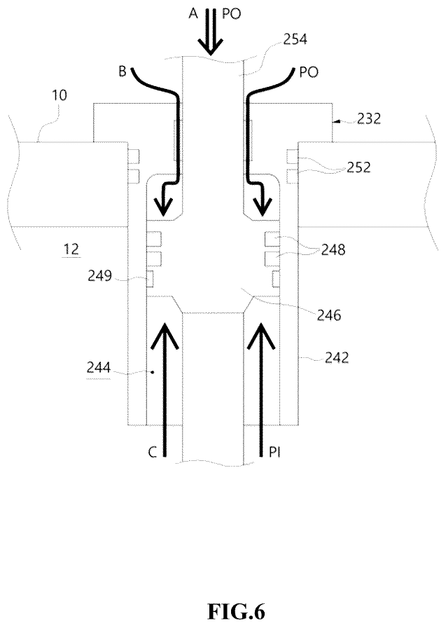

The vacuum circuit breaker (20) of the present disclosure may serve to connect and disconnect lines in the outer casing (10). As shown in FIG. 5, the fixed electrode (216) and the movable electrode (218) are in contact with each other to connect the line, and when an emergency signal is provided, the movable electrode is separated from the fixed electrode (216) by the operation of the operator (216) and cuts the line. For example, FIG. 1 shows a state in which the movable electrode (218) is separated from the fixed electrode (216).

The movable electrode (218) may be separated from the fixed electrode (216) when the operator (260) pulls the driving rod (254) upward based on the drawing. When the driving rod (254) is pulled, the piston (246) moves from one side of the cylinder (242) to the other side, that is, the outer direction of the outer casing (10), and the insulating rod (228) connected to the piston (246) moves together. The movement of the insulating rod (228) causes the movable rod (220) to move linearly, and the movement of the movable rod (220) moves the movable electrode (218) in a straight line to separate it from the fixed electrode (216).

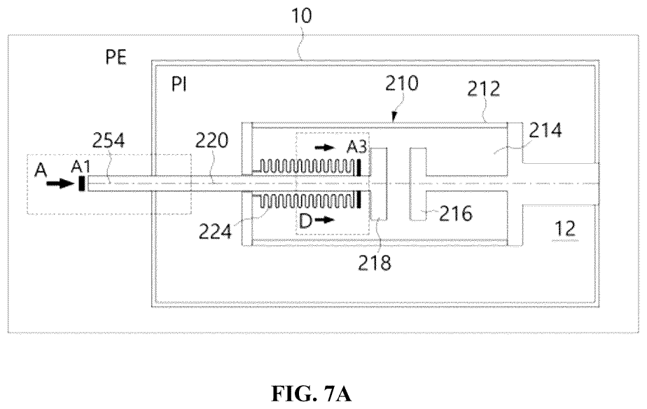

In such an operation, a force may act on the piston (246) as shown in FIG. 6. As seen in FIG. 6, the piston (246) is subjected to the pressure (PI) of the insulating gas in the inner space (12) because one surface of the piston (246) is exposed in the inner space (12) of the outer casing (10).

In addition, the rod wear ring (250) is installed in the rod through-hole (238) of the piston guide (232). Between the inner surface of the rod through-hole (238) and the driving rod (254), atmospheric pressure (PO) may act on the other surface of the piston (246). Therefore, the insulating gas pressure (PI) inside the outer casing (10) and the atmospheric pressure (PO) simultaneously act on the piston (246), resulting in a force in the opposite direction to the self-sealing force.

Meanwhile, due to the relationship between the pressure (PE) of the vacuum space (214) of the vacuum interrupter (210), the pressure (PI) of the inner space (12) of the outer casing (10), and the pressure (PO) outside the outer casing (10), that is, atmospheric pressure, a force may act on the components actuating the movable electrode (218).

The force (D) acting on the bellows (224) may be obtained by multiplying the effective area (A3) of the bellows (224) by the insulating gas pressure (PI) in the outer casing (10). That is, D=PI *A3.

The force (A) acting on the driving rod (254) may be obtained by multiplying the effective cross-sectional area (A1) of the driving rod (254) by the atmospheric pressure (PO). That is, A=PO * A1.

The forces (B, C) acting on the piston (246) are as follows. First, the force (B) exerted by the atmospheric pressure (PO) is obtained by multiplying the effective cross-sectional area (A2) of the piston (246) by the atmospheric pressure (PO). B=PO *A2. Next, the force (C) exerted by the pressure (PI) of the insulating gas inside the outer casing (10) is C=PI * A2. In general, the force C is greater than the force B.

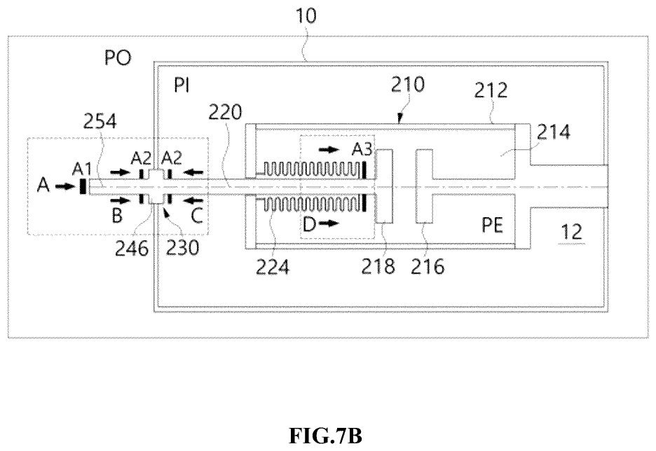

First, as seen in FIG. 7A, the force of A+D acts on the side of the movable electrode (218) by the pressure inside and outside the outer casing (10) and the vacuum of the vacuum interrupter (210). Accordingly, in order to separate the movable electrode (218) from the fixed electrode (216), the operator (260) requires more force.

However, as seen in FIG. 7B, the force CB acting on the piston (246) is less. That is, as shown in FIG. 7B, the force finally acting is (A+D)-(C−B). Therefore, the force acting on the movable electrode (218) side is relatively reduced compared to the prior art. Accordingly, the force required for the operation of the movable electrode (218) in the operator (260) may be relatively reduced.

In addition, when the effective diameter of the bellows (224) and the effective diameter of the piston (246) (or the effective diameter of the airtight packing (248)) are the same or almost the same, the self-sealing forces of the vacuum interrupter (210) during the opening and closing operation and the magnitude of the load due to the pressure difference between the inside and outside of the outer casing (10) are similar, so that the operating speed of the movable electrode (218) may be constantly implemented during the opening and closing and input operations.

Even though it has been described that all components constituting the embodiments of the present disclosure are combined into one or operated in combination with each other, the present disclosure is not necessarily limited to the embodiments. That is, within the scope of the objective of the present disclosure, all of the components may be selectively combined into at least one and operated. In addition, the terms such as “include”, “consist of”, or “have” described above mean that the corresponding component may be present unless otherwise stated, and thus should be construed that the terms do not exclude other components, but may further include other components. All terms, including technical or scientific terms, have the same meaning as commonly understood by those skilled in the art to which the present disclosure belongs, unless defined otherwise. Generally used terms, such as terms defined in the dictionary, should be interpreted as being consistent with the contextual meaning of the related art, and should not be interpreted in an ideal or excessively formal meaning unless explicitly defined in the present disclosure.

The above description is merely illustrative of the technical idea of the present disclosure, and those skilled in the art to which the present disclosure belongs may perform various modification and changes within the scope not departing from the essential characteristics of the present disclosure. Accordingly, the embodiments disclosed in the present disclosure are not intended to limit, but to explain the technical idea of the present disclosure, and the scope of the technical spirit of the present disclosure is not limited by these embodiments. The scope of protection of the present disclosure should be interpreted by the claims below, and all technical spirits within the scope equivalent to the scope of the claims should be interpreted as being included in the scope of the claims of the present disclosure.

1. A vacuum circuit breaker, parts of which are located inside an outer casing and other parts are installed penetrating the outer casing, comprising:
a vacuum interrupter disposed inside the outer casing, wherein a vacuum space is formed inside a housing, the vacuum space having a fixed electrode and a movable electrode that contacts and separates from the fixed electrode; and
a linkage mechanism comprising a driving rod which is installed penetrating the outer casing for transmitting a force required to drive the movable electrode and a piston which is integral with the driving rod and has an outer diameter greater than that of the driving rod.

2. The vacuum circuit breaker of claim 1, wherein the linkage mechanism further comprises a piston guide installed penetrating the outer casing,
wherein a guide body of the piston guide is provided with a rod through-hole through which the driving rod passes and communicates with the outside of the outer casing and a cylinder in which the piston is movably installed and opens into the outer casing.

3. The vacuum circuit breaker of claim 2, wherein an airtight packing and a piston wear ring are provided between the outer surface of the piston and the inner surface of the piston space.

4. The vacuum circuit breaker of claim 2, wherein a rod wear ring is provided between the inner surface of the rod through-hole and the outer surface of the driving rod.

5. The vacuum circuit breaker of claim 1, wherein a movable rod having one side connected to the movable electrode and the other side connected to the linkage mechanism is provided penetrating the housing,
wherein a bellows seals between the movable rod and the housing.

6. The vacuum circuit breaker of claim 5, wherein the effective diameter of the bellows and the outer diameter of the piston have the same value.

7. The vacuum circuit breaker of claim 6, wherein a guide tube is installed penetrating the housing and the movable rod is disposed penetrating the guide tube,
wherein the bellows is installed between the guide tube and the movable rod.

8. The vacuum circuit breaker of claim 5, wherein an insulating rod made of an insulating material is further provided between the movable rod and the piston of the linkage mechanism.

9. The vacuum circuit breaker of claim 1, wherein a piston guide in which the piston and the driving rod of the linkage mechanism are installed is installed penetrating the outer casing,
wherein a mounting flange is formed around one side of the outer surface of a guide body forming the skeleton of the piston guide, so that one surface of the mounting flange is in close contact with the outer surface of the outer casing.

10. The vacuum circuit breaker of claim 9, wherein a rod through-hole through which the driving rod passes is formed penetrating the center of the guide body,
wherein a cylinder having a cylinder space in which one side of the cylinder communicates with the rod through-hole and the other side thereof communicates with the inner space of the outer casing protrudes toward the vacuum interrupter.
